(19) United States
(12) Patent Application Publication
(10) Pub. No.: US 2023/0419078 A1
(43) Pub. Date: Dec. 28, 2023

(54) CUSTOMIZATION OF FORECASTING SOLUTIONS

(71) Applicant: Zycus Infotech Pvt Ltd, Mumbai (IN)

(72) Inventor: Sanjay Kumar Singh, Mumbai (IN)

(73) Assignee: Zycus Infotech Pvt Ltd, Mumbai (IN)

(21) Appl. No.: 18/117,425

(22) Filed: Mar. 4, 2023

(30) Foreign Application Priority Data
Mar. 24, 2022 (IN) 202221016594

(51) Int. Cl. G06N 3/045; G06N 3/044

(52) U.S. Cl. CPC G06N 3/045; G06N 3/044

(57) ABSTRACT

Forecasting solutions including customization of raw data using uncertainty coefficient and using ensemble neural network architecture. The raw data is customized by cleaning and augmenting to obtain a processed dataset that is non-discreet and continuous, and; the ensemble neural network architecture is customized to include plurality of dependent and independent features to obtain ensembled weights from ensemble recurrent neural network (RNN) type architecture, a one versus rest ensemble RNN architecture and a forest of ensemble, to obtain an appropriate forecasting model that includes dynamically adaptive weights from ground truth along with the ensembled weights to create a final weighted output such that the final weighted output/forecast result has more accuracy and reduced false positives. The present invention allows for feedback mechanism from disruptive forecasting results if any from query module to go back to training module that enhances the accuracy of the next result without re-training.

### CROSS-REFERENCE TO RELATED APPLICATION

The instant application claims priority to Indian Patent Application Serial No. 202221016594, filed Mar. 24, 2022, pending, the entire specification of which is expressly incorporated herein by reference.

### FIELD OF THE INVENTION

The present invention generally relates to customization of forecasting solutions, and it particularly relates to customization of forecasting solutions for price, demand and supply forecasting for spend data management.

### BACKGROUND OF THE INVENTION

Forecasting is predicting the future price, demand and supply of a commodity based on historical data. Forecasting can be done in a number of ways and has been a way for spend data management to predict future needs in order to be able to fulfil them efficiently.

Forecasting was done traditionally by statistical methods, general analysis of data or by combination of these. Further forecasting was even automated by the use of computers to analysis stored data. However, most of the forecasting techniques faced some or the drawback.

There are different types of forecasting methods available. When forecasting time series data, the aim is to estimate how the sequence of observations will continue into the future. The simplest time series forecasting methods use only information on the variable to be forecast, and make no attempt to discover the factors that affect its behaviour. Therefore, they will extrapolate trend and seasonal patterns, but they ignore all other information such as marketing initiatives, competitor activity, changes in economic conditions, and so on.

Forecasting requires selection of appropriate model. The best model to use depends on the availability of historical data, the strength of relationships between the forecast variable and any explanatory variables, and the way in which the forecasts are to be used. It is common to compare two or three potential models. Each model is itself an artificial construct that is based on a set of assumptions (explicit and implicit) and usually involves one or more parameters which must be estimated using the known historical data.

Once a model has been selected and its parameters estimated, the model is used to make forecasts. The performance of the model can only be properly evaluated after the data for the forecast period have become available. A number of methods have been developed to help in assessing the accuracy of forecasts. However, most of the methods existing till date fail to have accurate prediction especially when there is abrupt deviation in the data due to some drastically changed environment. For example, the spend data management suffered heavily in terms of accurate forecasting due to the coronavirus pandemic, a factor which did not affect the calculations before the pandemic.

Nonlinear pricing and demand combined with non-continuous time series data make it difficult to forecast with (statistical) traditional algorithms like, least square regression, moving average, auto regression, auto regression integrated moving average, and exponential smoothening. Neural network architecture in silos on univariate and multivariate prove to be ineffective leading to over fitted models for materials with fluctuations in price and demands over a period.

Time series forecasting using aforementioned techniques are not new, but the challenge remains due to characteristics of ever-changing pricing or demands while failing the stationarity, as we know dataset with no stationarity leads to instability in forecasting. In procurement and spend management there does not exist much of a choice but to go with statistical methods and be proactive in reactively changing dollar values over period of time, involving great deal of manual intervention.

Known forecasting techniques fail on accurate prediction when there is sudden surge, no case stationarity and volatile pricing and demand. While predicting a spend forecasting for inventory management or budgeting the error has to be minimal. All the presently available forecasting solutions have a very high error rate, and an error rate of 15% or more can inflate a budget. Therefore, there is need for a forecasting solution that is accurate, reduces false positives, and takes into account deviations to give an output as close to real data.

### PRIOR ART

U.S. Pat. No. 8,341,007 discloses systems and methods for forecasting demand for objects, such as products, parts, etc. in a managed supply chain. In one embodiment, a method for forecasting demand is provided that comprises the step of determining a forecast profile including a forecast model and a forecast parameter to be assigned to a set of data forming the basis of the forecast. U.S. Pat. No. 8,341,007 relies on historical data as input and lacks any customization of data as like the forecasting solution of the present invention. U.S. Pat. No. 8,341,007 does not mention neural network architecture based model to predict the demand and works mostly on re-training if error is more than acceptable. U.S. Pat. No. 8,341,007 does not take into account ground truth and thus, in disruptive scenarios may not be able to predict accurately unlike the present invention.

U.S. Patent Publication No. 2018/0130072 discloses a method, apparatus and computer program product configured to train and deploy a predictive model that is configured to generate a predicted ROI value for a provider with respect to a current promotion or a future promotion. An example embodiment may comprise receiving input indicative of one or more attributes of a provider or a promotion. The example embodiment may further comprise generating at least one of a predicted return on investment (ROI) value or a predicted ROI component value based at least in part on the one or more attributes of the provider of the promotion prediction model. The method may further still comprise generating a merchant impact report including the at least one of the predicted ROI value or the predicted ROI component value for the promotion. U.S. Patent Publication No. 2018/0130072 relies on historical data as input and lacks any customization of data as like the forecasting solution of the present invention thus lack accuracy for anomalies if any. U.S. Patent Publication No. 2018/0130072 does not mention neural network architecture-based model and forest of ensemble neural network to predict the demand U.S. Patent Publication No. 2018/0130072 does not take into account ground truth and thus in disruptive scenarios may not be able to predict accurately unlike the present invention.

The present invention discloses customization of forecasting solutions that have potential to incorporate external risk factors without having them featured into the data and thus provide an accurate forecasting solution to the customers.

### OBJECTS OF THE INVENTION

The primary object of the present invention is to provide a forecasting solution for spend management that is customized to give more accurate and more precise prediction.

Yet another objective of the present invention is to optimize forecasting solutions through group of tasks to provide a unique solution to forecasting.

Yet another objective of the present invention is to prepare processed data by customizing raw data to obtain continuous and non-discreet data.

Yet another objective of the present invention is to prepare multiple multi step ensemble neural network models having combination of customized components.

Yet another objective of the present invention is to offer forecasting solutions to customers that are among the best in the market and those that take into consideration the volatile aspects too.

### Definitions

Random Forest Algorithms—random forest is a supervised machine learning algorithm that is used widely in classification and regression problems. It builds decision trees on different samples and takes their majority vote for classification and average in case of regression. One of the most important features of the random forest algorithm is that it can handle the data set containing continuous variables as in the case of regression and categorical variables as in the case of classification. It performs better results for classification problems.

Ensembles—ensemble simply means combining multiple models. Thus, a collection of models is used to make predictions rather than an individual model.

Neural Networks—neural networks are complex structures made of artificial neurons that can take in multiple inputs to produce a single output. This is the primary job of a neural network—to transform input into a meaningful output. Usually, a neural network consists of an input and output layer with one or multiple hidden layers within. Neural network ensemble is a learning paradigm where many neural networks are jointly used to solve a problem.

Weight—is the parameter within a neural network that transforms input data within the networks hidden layers. A neural network is a series of nodes, or neurons. Within each node is a set of inputs, weight, and a bias value. As an input enters the node, it gets multiplied by a weight value and the resulting output is either observed, or passed to the next layer in the neural network. Often the weights of a neural network are contained within the hidden layers of the network. Weights are numeric values which are multiplied with inputs. In backpropagation, they are modified to reduce the loss. In simple words, weights are machine learnt values from neural networks. They self-adjust depending on the difference between predicted outputs vs training inputs. By contrast, dynamic methods can determine the adaptive weights on the basis of the characteristics of the sample; these weights can effectively emphasize the decision-making contribution made by excellent classifiers and suppress the influence of unreliable information output by use of high-deviation classifiers on classification.

Data augmentation—data augmentation in data analysis are techniques used to increase the amount of data by adding slightly modified copies of already existing data or newly created synthetic data from existing data. It acts as a regularizer and helps reduce overfitting when training a machine learning model.

Data Normalization—normalization is the process of organizing data in a database. This includes creating tables and establishing relationships between those tables according to rules designed both to protect the data and to make the database more flexible by eliminating redundancy and inconsistent dependency.

Dynamically adaptive weight—dynamically adaptive weight can be defined as custom additional weights generated to counter the deviations of model generated ensemble weights during the training time in the training module, this weight is a function of ensemble weights and ground truth.

### SUMMARY OF THE INVENTION

The present invention discloses forecasting solutions that are customized to give accurate and precise predictions. The present forecasting solution is based on dynamically adaptive weights for forecasting using ensemble neural network architecture. The present invention solves many problems of the prior art wherein the forecasting models suffered with inaccurate predictions especially in case of some anomalies detected in the historical trend due to sudden surge or fall.

The present invention discloses customization of forecasting solutions using multiple multi-step ensemble neural network architecture. The neural network used is recurrent neural network (RNN) architecture with plurality of features like but not limited to price, demand, spend, payment patterns, demographic, requisitioner, buyer, supplier. Further in the present invention there is automation done for augmentation of some features like but not limited to business volume, business frequency, recency factor on price and demand, unit of measure.

The present invention as one of its novel features customizes the input raw data to be used for forecasting model. The input raw data is cleaned and augmented to be as close as real data. The data preparation and augmentation for missing values and ranking of top features is done using formulas for uncertainty coefficient.

The second novel aspect of the present invention is the use of multiple step ensemble neural network architecture for custom components namely; ensemble based on unique feature grouping, one vs. rest ensemble neural network architecture and forest of ensemble models. None of the prior art uses ensemble of RNN architecture with data augmentation, one vs. rest ensemble model or forest of emblem models together for forecasting. Hence the present invention is a unique solution to the forecasting problems.

The inventiveness of the present invention lies not only in its use of augmented data with feature grouping in ensemble models or the use of forest of ensemble but also, in the step of deducing dynamically adaptive weights from ensemble weights of the multiple individual RNN architectures and mutually exclusive architecture.

One of the novel features of the ensemble models of the present invention also includes use of past predictive weights along with ground truth to create dynamically adaptive weights which are merged with the ensemble weights of the ensemble RNN by the virtue of dynamic adaptive weight module to give a single output which is close to reality and is least non-relevant.

The present invention through its one vs. rest ensemble model works with plurality of variable features that are relevant and can affect the values of the output data. The weighted outputs of the networks have a factored in feature of relevancy ranking. Based on the most relevant features the output of that relevant network is selected for the final output calculations.

The present invention describes yet another novel approach of using forest of ensembles. This approach combines multiple RNN heterogeneous architecture where heterogeneousness signifies; different features set on different architecture being trained on the same training data set. The architectures are combined using ensemble weights and dynamically adaptive weights deduced from dynamic loss function from group of RNN architecture designed. These dynamically adaptive weights act as a constraint to generate opposite weight against RNN heterogeneous ensembles output loss thus generating a custom single output that is relatively closer to the actual results as compared to output generated by other known methods in prior art. The less non-relevant decisions of more than one network-based architecture on different grouping features are combined and presented as one output which is close to real time values. The weighted outputs of the neural networks have a factored in feature of relevancy ranking based on the confidence score generated by custom weights. Based on the most relevant features the output of that relevant network is selected for the final output calculations.

Known forecasting solutions usually fail on surge (positive/negative), struggle in smoothening in case stationarity is not achieved, have bad accuracy for items with volatile pricing, demands (target/dependent variables). The present invention addresses the challenge of deducing near perfect data augmentation, increased accuracy and reduction in false positives for forecasting models.

### BRIEF DESCRIPTION OF THE DRAWINGS

The present invention, together with further objects and advantages thereof, is more particularly described in conjunction with the accompanying drawings in which:

FIG. 1 depicts the ensemble neural network model with recurrent neural network (RNN) 1, 2, 3 . . . n runs, on different time series features on different windows described as 1 week, 4 weeks, 24 weeks or N weeks leading to ensemble weights of each series. The figure further depicts how these ensemble weights undergo dynamically adaptive weight (observing loss pattern on targets over n epochs) component leading to final output;

FIG. 2 depicts parallel ensembles of deep learning for identified features grouping based on “uncertainty coefficient” relationship between target (x) and independent/dependent features (y). This architecture enables incremental learning through the observed loss pattern for provided target using state of art neural network architecture;

FIG. 3 depicts an overview of the forecasting system of the present invention;

FIG. 4 depicts the flow of interaction between training module and query module (forecasting model) in real-time use; and

FIG. 5 depicts a table illustrating an output of the present customized forecasting solution wherein forecasting is done for two demography namely; United States and Europe for the months of April, May and June 2020.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

According to one embodiment of the present invention there is described customization of forecasting solutions for state of art forecasting based on dynamically adaptive weights using ensemble of RNN architecture, one vs. rest ensemble model and forest of ensemble models. The forecasting solution enables to accurately predict the price, demand or supply of any commodity for any inventory or spend data management for budgeting, etc. The forecasting solution comprises creating/developing an appropriate forecasting model such that precise and accurate forecasting is achieved and the error is minimal or zero. The determining aspect of the present invention is customization of raw data in the data preparation step to obtain processed dataset and then constructing specific multiple multi step ensemble neural network architecture based model using custom components.

In order to prepare the forecasting model for prediction first, a training module undergoes all the training. The raw data to be used as input is customized to obtain a processed dataset for all of the plurality of features available. This processed data then is passed through various steps of the training module wherein the processed data is run with multiple multi step ensemble neural network architecture to give a weighted output of each run also using ground truth values. Many combinations of neural networks based on different feature grouping with multiple ensemble models are run and their output is combined to form one single final weighted output. The forecasting model so formed during training is used for the query run for forecasting.

Customization of Raw Data.

The first step to train a training module for forecasting is to ready a processed dataset from raw data. The raw data available historically needs to be pre-processed to be fed into the appropriate formula/model or, to run it with a selected neural network architecture. Most of the data available for forecasting is sporadic in nature and therefore concreteness needs to be brought into the raw data for an accurate output for use in neural network or ensemble neural networks to obtain a forecasting model that can give precise output. In time-series forecasting with recurrent neural network (RNN) architecture in order to have a precise and accurate forecasting, it is necessary that the data should be non-discrete, concrete, and continuous.

The present invention involves customization of raw data by cleaning and augmenting the raw data. This cleaning and augmentation are carried out using the uncertainty co-efficient formula with Thiel's constant.

Data pre-processing—The present invention works with time-series model and makes use of outlier correlation matrix with data running over in the span of week time (one week, two weeks, three weeks, n weeks). For a year's dataset this distribution is executed to run for weekly, monthly and quarterly while adjusting the target values (x) by breaking model into multiple sub models with groupings identified via outlier correlation matrix data to augment price and demand based on the following formulas:

$${price}_{normalized \_ {for}_{{nth}_{month}}} = \qquad FORMULA 1$$

$$\frac{\{ median ( {price}_{{of}_{{last}_{{n}_{month}}}} ) - \frac{1}{n} {\sum }_{i = 0}^{n} price \}}{\frac{\{ \sqrt{{price}_{i} - \frac{1}{n {\sum }_{i = 0}^{n} price}} \}}{n}}$$

$${demand}_{normalized \_ {for}_{{nth}_{month}}} = \qquad FORMULA 2$$

$$\frac{\{ median ( {demand}_{{of}_{{last}_{{n}_{month}}}} ) - \frac{1}{n} {\sum }_{i = 0}^{n} demand \}}{\frac{\{ \sqrt{{demand}_{i} - \frac{1}{n {\sum }_{i = 0}^{n} demand}} \}}{n}}$$

The target value to be deduced say price as in formula 1 if is considered to be y, the dependent features are considered as input x, similarly for demand as in formula 2, target values considered as y, then all independent features are considered as input x.

One of the novel aspects of the present invention is its use of varied dependent and independent features. The plurality of features used in the customization of forecasting solutions are multivariate, consisting of contractual parameters, payment patterns, demographic details, business recency, business volume, business frequency over a period etc. Some the features used in the present invention for price and demand forecasting are like but limited to: price, demand, spend, payment patterns, demographic, requisitioner, buyer, and supplier.

The present invention goes a step further and as a novelty feature automates the input data for some other features like business volume, business frequency, recency factor on price and demand, and unit of measure.

The raw data available for these features are customized to obtain a processed dataset. The data is broken down at week level (1 week, 4 week, 24 weeks, n weeks) to create “n” independent series with varying features with respect to categorical or numerical features in a data apart from time series feature.

Data augmentation—The input data (pre-processed one) for price and demand deduced through (Theil's U) uncertainty coefficient and formulas as given above are applied on price and demand output along with the combined weights to bring about data augmentation for the price and demand deviations for the missing months/weeks/days etc. by using features as mentioned above.

Data normalization is done to avoid any redundancy of data. The input data is normalized based of different categories to also avoid redundancy or wrong categorization. This step in itself forms a part of patentable subject matter.

Once a processed dataset is ready, the ensemble neural network architecture imparts an incremental learning to the model through its individual and mutually exclusive neural network architectures (ensemble RNN, one vs. rest ensemble model, ensemble forest). Models are created for each feature as given above and the output of all the models are aggregated into the ensemble model by known techniques of aggregation.

The processed dataset obtained after customization of raw data as described in the data processing step above is used to create a desired ensemble neural network architecture by training the training module.

Preparing multiple multi step ensemble neural network architecture based model using custom components.

The present invention uses a novel approach wherein once customization of raw data is done to obtain a processed dataset; this processed dataset is then used in a uniquely customized neural network architecture to obtain accurate forecasting solutions. These architectures make use of multiple multi step ensemble RNN using customized components. The neural networks are both individual and mutually exclusive. Firstly, several different kinds of feature selection methods are used to evaluate the performance of the training data, and then each such training generates a subset. Secondly, the single subset acquired from such training is used to train a model separately. Finally, the results of these different models are aggregated to create one single output.

Ensemble Neural Network Architecture.

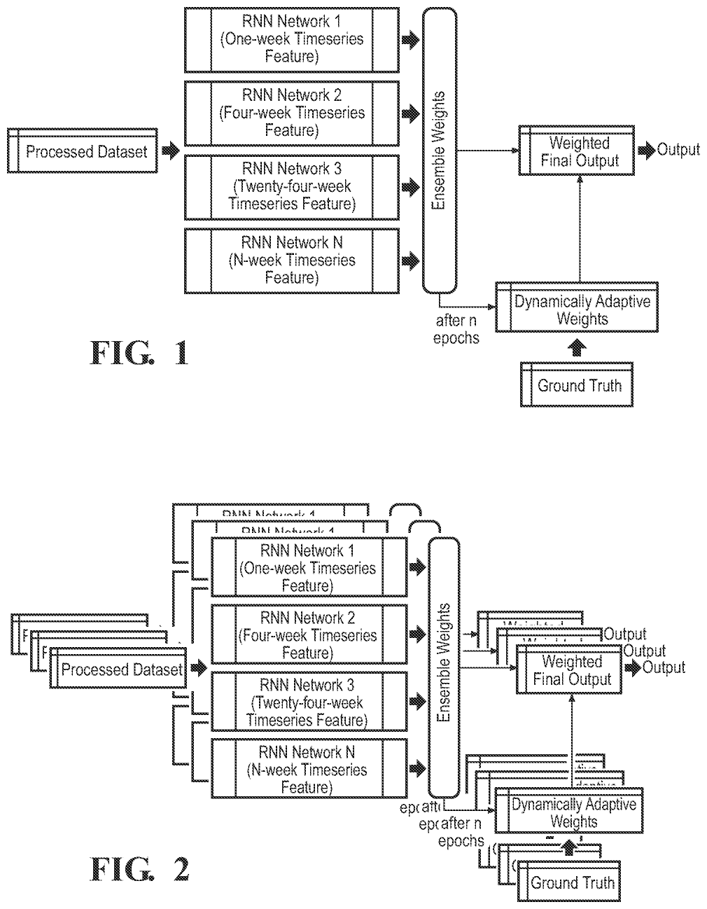

FIG. 1 in accordance to the embodiment of the present invention depicts an ensemble recurrent neural network (RNN) architecture with varied window of time for run on different time series features which then creates an ensemble weight taking into consideration the best/appropriate time series feature that is closest to real data or is less non-relevant. From the deduced ensemble weights after every n epochs the model readjust its weight resulting in dynamic weights per grouping (grouping deduced through uncertainty coefficient), this adjustment phenomena over a period of continuous sliding window manages to flatten the volatility in target features. The processed dataset used to run in the ensemble is the one with relevant features as identified from the uncertainty co-efficient in the data preparation step of customization of data. This ensemble RNN method is applied one vs. rest on top features identified by uncertainty coefficient. The neural network architecture of the present invention is a combination of individual neural network and mutually exclusive neural network architecture.

One of the novel features of the present invention includes use of past predictive weights along with ground truth to create dynamically adaptive weights which are in turn taken into consideration with the ensemble weights of the ensemble RNN to give an output which is close to reality and is least non-relevant. Generated output from each individual and mutually exclusive neural network architecture is subject to processing by virtue of dynamically adaptive weight module having stored information of adaptive weights deduced from past predictive weights. Dynamically adaptive weights uses ground truth to generate additional error (residual) apart from error generated by respective neural network architecture. The dynamically adaptive weights by virtue of adaptive weight module are merged with ensemble weights of respective neural network architecture by applying distinct mathematical expressions like but not limited to product, sum, mean, median, mode to normalize to generate a single weighted output. This final single output is shared as a predicted value to the user/customer for the given request/query with error threshold.

The present invention describes a novel and inventive ensemble recurrent neural network (RNN) architecture unlike the models in prior art for forecasting. The ensemble of the present invention creates dynamically adaptive weights from the ensembled weights for each different neural network (time-series). The RNN architecture is trained and generates output for each batch (n epochs) and passes on that information/state to validate against the ground truth in order to readjust weights for next batch of n-epochs. This process continue until the loss on actual data stabilizes, here model is learning n^{th} step target value, then n^{th} value goes as input to generate n+1^{th} value output and so on. The ensembled weights (pre-trained weights) obtained from the RNN architecture after n epochs and the dynamic adaptive weights deduced from past predictive weights taken from the ground truth together form the weighted output of each model. This aspect of using ground truth to form dynamically adaptive weights is also a unique aspect of the present invention. Most of the prior arts do not work with ground truth and dynamically adaptive weights from the past and thus cannot give accurate results in case of unstable data with gaps.

Neural Network Architecture for Forecasting (One Vs. Rest Ensemble Weights).

Ensemble RNN as described above deduces output taking into consideration one feature at a time, in a time-series; however, there are many hidden features not visible openly that affect price and demand in day-to-day transaction. The present invention through its one vs. rest ensemble takes into account more than one such variable features that are relevant and can affect the values of the output data. The weighted outputs of the networks have a factored in feature of relevancy ranking. Based on the most relevant features the output of that relevant network is selected for the final output calculations.

FIG. 2 in accordance to the embodiment of the present invention depicts the RNN architecture as in FIG. 1 replicated number of times for varying features for the same time span say of one week, four weeks, twenty-four weeks etc. All the weighted outputs of the ensemble of networks for different feature groupings are averaged out to produce a single final output. Forecasting of one item can be described as mean of predicted ensemble weights from the parallel ensemble architecture weighted with dynamically adaptive weights from accumulated over run of n batches wherein each such batch internally are adjusted by the weights of all n batches run as also depicted in FIG. 1.

This method of use of one vs. rest ensemble model for forecasting imparts the present invention the novelty and inventiveness of taking into consideration any sudden, random change in behaviour of any value pertaining to any feature which may have undergone a sudden decline or rise due to some external factors. When each such feature is run separately in an independent neural network architecture and their results combined, the ensemble is sure to capture some deviations which could be missed when running all features together. Most of the forecasting systems present in the prior art when working with longer time frame of say 3 years or 5 years of dataset do not take into account such steep decline or rise in real time values of individual feature for few weeks or months and consider it anomaly to be ignored. The present invention thus distinguishes itself from the prior art.

This step in the customization of forecasting solutions of the present invention helps bring the predictive price close to the actual price and reduces losses and is an inventive feature of the present invention. For example, the sudden fall of prices or demand and supply frequency during initial months of coronavirus pandemic hit months was a challenge that could not be addressed by the forecasting system in the prior arts.

Forest of Ensemble Neural Networks.

The present invention describes forecasting solutions using forest of ensembles as one of its novel aspects, where this approach combines multiple RNN heterogeneous architecture, where heterogeneous architecture signifies running different feature set on different architecture on same training data set, the architecture is combined using ensemble weights and dynamically adaptive weights deduced from dynamic loss function from group of RNN architecture designed, this dynamic weights acts as a constraint to generate opposite weight against RNN heterogeneous ensembles output loss thus generating a custom single output that is relatively closer to the actual results as compared to output generated by other known methods. The less non-relevant decisions of more than one network-based architecture on different grouping features are combined and presented as one output which is close to real time values. The weighted outputs of the neural networks have a factored in feature of relevancy ranking based on the confidence score generated by custom weights. Based on the most relevant features the output of that relevant network is selected for the final output calculations.

In yet another embodiment of the present invention is described the query module of forecasting. Once a processed dataset is obtained by data pre-processing, augmentation and normalization and an appropriate recurrent neural network (RNN) architecture is selected to run the said data in ensemble, one vs. rest and forest ensemble techniques, an appropriate forecasting model can be deduced from the training module. The forecasting model so obtained can be used for any new input data. The user/customer needs to hit the query to the deduced forecasting model to obtain the prediction for the required feature for his/her spend management.

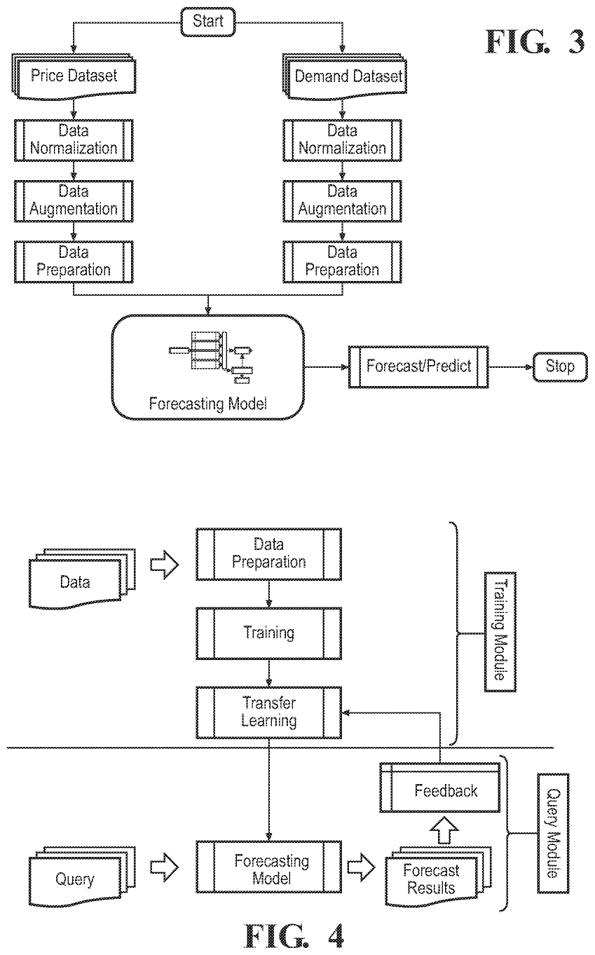

FIG. 3 in accordance to the embodiment of the present invention is general flow of steps in training and forecasting for time-series RNN architecture ensemble forest model.

This workflow describes a process for training forecasting model for demand and price as a common workflow, here data normalization, augmentation and preparation pipelines involve customization based on specific features to generate ensemble forest of neural network as an outcome of this process.

In yet another embodiment of the present invention is described a unique arrangement between the training module and the query module of the forecasting solution of the present invention. This arrangement allows the training module to take the feedback of the output/forecast result (predictions done) by the developed forecasting model. Those output predicted by the developed forecasting model where the predictions have higher deviations or are disruptive are sent back to the training module. This feedback is stored in the training module. This transfer learning thereby enhances forecasting results and avoids false positives, surges etc.

The customized forecasting solution of the present invention is such that no re-training is required by the model once developed. The feedback from the forecast results of the input query helps the forecasting model to readjust itself to deviations found if any and autocorrect the error in the next run of query.

### EXAMPLE

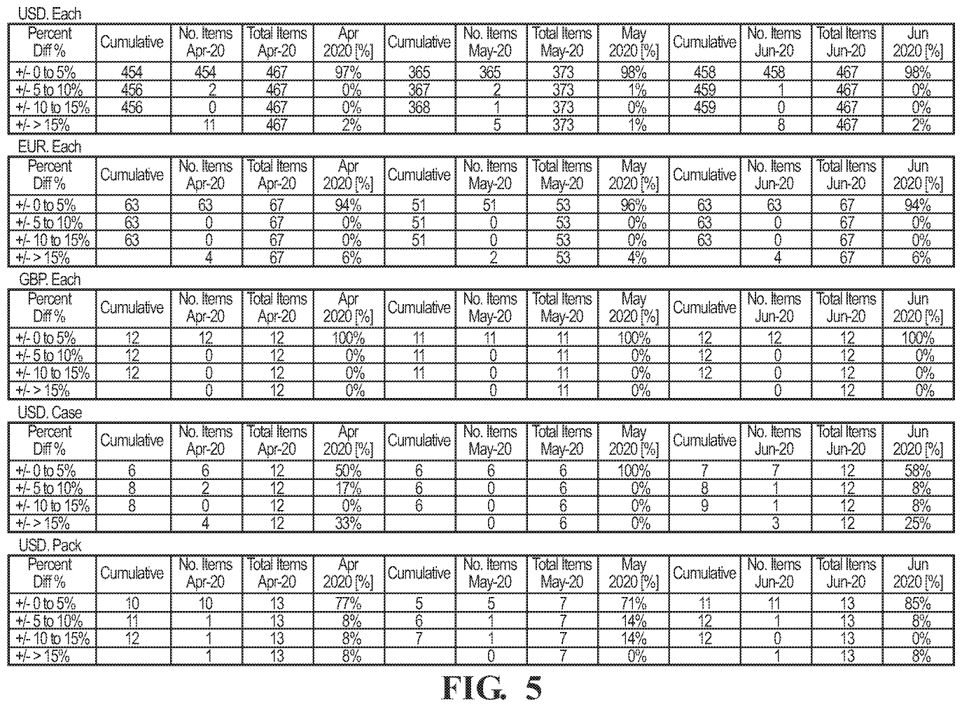

FIG. 5 is an output of the present customized forecasting solution wherein forecasting is done for two demography namely; United States and Europe for the months of April, May and June 2020.

FIG. 5 depicts that the forecasting solution of the present invention predicted with 97% accuracy for the month of April, with 98% accuracy for the month of May, and with 98% accuracy for the month of June at 0 to 5% error rate for the jurisdiction of United States during the initial months of the coronavirus pandemic wherein the entire world market, inventories, etc. were facing tremendous changed patterns of spend data with highly discrete values.

FIG. 5 further depicts that the forecasting solutions of the present invention predicted with 94% accuracy for the month of April, with 96% accuracy for the month of May, and with 94% accuracy for the month of June at the rate of 0 to 5% error rate for the European jurisdiction during the initial months of coronavirus pandemic wherein the entire world market, inventories etc. were facing tremendous changed patterns of spend data with highly discrete values.

In yet another embodiment of the present invention are described steps involved in pre-designing of a neural network architecture for training a model for forecasting as follows:
Firstly raw data is acquired/identified from available resources;
Identified raw data is processed for features like but not limited to price, demand, spend, payment patterns and details, demographic details, requestioner details, buyer details, supplier details, unit of measure, etc. and the related information is extracted;
Additional features like but not limited to business volume, business frequency, recency factor on price and demand and the related information is augmented;
Missing data for any feature is generated using formulas 1 and 2 to obtain a final processed dataset;
Processed dataset so generated is fed to pre-designed multiple individual neural network architecture and mutually exclusive neural network architecture for processing;
The recurrent neural network architecture processes the dataset as one vs. rest on top feature to create multiple recurrent neural network architectures, and also creates forest of ensemble of such multiple recurrent neural network architectures for different feature grouping combined together;
Generated weighted outputs from each individual and mutually exclusive neural network architecture is subject to processing by dynamically adaptive weight module having stored information of dynamic adaptive weights deduced from past predictive weights;
The dynamically adaptive weight module uses ground truth to generate additional error (residual) apart from error generated by respective neural network models;
The dynamically adaptive weights from adaptive weight module are merged with generated weights of respective neural network architecture (ensemble weights) by applying distinct mathematical expressions like but not limited to product, sum, mean, median, mode to normalize and generate a single weighted output; and
Final single output is shared as a predicted value/forecast result to the user/customer for the given request/query with error threshold.

The forecasting solutions of the present invention has advantage over existing prior arts in that, the present invention allows for selection of features and relevancy ranking of features (dependent or independent) that influence the output. Further every specific ensemble model is activated based on weighted output. The present invention due to its novel RNN architecture and forest ensemble taking into consideration ground truth is able to give accurate and precise forecasting results/output for any query by the user/customer and is able to give predictions that are close to real data.

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for the customization of forecasting solutions, comprising:
raw data and ensemble neural network architecture;
wherein the raw data is customized by cleaning and augmenting to obtain a processed dataset that is non-discreet and continuous, and the ensemble neural network architecture is customized to include plurality of dependent and independent features to obtain ensembled weights from:
ensemble recurrent neural network (RNN) type architecture;
a one versus rest ensemble RNN architecture; and
forest of ensemble;
to obtain an appropriate forecasting model that includes dynamically adaptive weights from ground truth along with the ensembled weights to create a final single weighted output such that the final weighted single output/forecast result has more accuracy and reduced false positives.

2. The invention as claimed in claim 1, wherein the cleaning and augmentation is done using uncertainty co-efficient to deduce missing values in raw data and, to do relevancy ranking to group top features such that the deduced data is as good as real data.

3. The invention as claimed in claim 1, wherein the ensemble neural network architecture of the present invention is a recurrent neural network (RNN) which creates dynamically adaptive weights for plurality of features run separately in a time-series fashion.

4. The invention as claimed in claim 1, wherein the recurrent neural network (RNN) is applied in one versus rest ensemble neural network architecture model on top features identified by uncertainty coefficient to obtain combined output of different grouping features.

5. The invention as claimed in claim 1, wherein the forest of ensemble is a combination of multiple RNN heterogeneous architecture of different feature set/grouping on different architecture on same data set, such that the final output of the forest is the combination of ensemble weights and dynamically adaptive weights deduced from dynamic loss function from group of RNN architecture.

6. The invention as claimed in claim 1, wherein the ensemble of RNN architecture of the present invention is enabled to generate output for n epochs and pass on the information to the ground truth for validation to readjust the ensemble weights to obtain data stabilization.

7. The invention as claimed in claim 1, wherein the forecasting model obtained from a training module is used in the query module for forecasting.

8. The invention as claimed in claim 1, wherein designing the neural network architecture to obtain a forecasting model from a training module comprises the steps of:
raw data is acquired/identified from available resources;
identified raw data is processed for features like but not limited to price, demand, spend, payment patterns and details, demographic details, requestioner details, buyer details, supplier details, unit of measure etc. and the related information is extracted;
additional features including business volume, business frequency, recency factor on price and demand and the related information are augmented;
missing data for any feature is generated using formulas 1 and 2 to obtain a final processed dataset;
processed data so generated is fed to pre-designed multiple individual recurrent neural network architecture and mutually exclusive recurrent neural network architecture for processing;
the recurrent neural network architecture processes the dataset as one versus rest on top feature to create multiple recurrent neural network architectures, and also creates forest of ensemble of such multiple recurrent neural network architectures for different feature grouping combined together;
generated weighted outputs from each individual and mutually exclusive recurrent neural network architecture are subject to processing by a dynamically adaptive weight module having stored information of adaptive weights deduced from past predictive weights;
the dynamically adaptive weight module uses ground truth to generate additional error apart from error generated by respective neural network models;
the weights from dynamically adaptive weights module are merged with generated weights of the respective neural network architecture by applying distinct mathematical expressions like but not limited to product, sum, mean, median, mode to normalize and generate a single weighted output; and
final single output is shared as a predicted value to the user/customer for the given request/query with error threshold.
